(19) United States
(12) Patent Application Publication
(10) Pub. No.: US 2023/0268098 A1
(43) Pub. Date: Aug. 24, 2023

(54) SHIELDED CABLE AND SHIELDED-CABLE MANUFACTURING APPARATUS

(71) Applicant: SUMITOMO WIRING SYSTEMS, LTD., Yokkaichi-shi (JP)

(72) Inventors: Masaya FUJIKURA, Yokkaichi-shi (JP); Koki SHIGA, Yokkaichi-shi (JP); Yuki MAKIGAWA, Yokkaichi-shi (JP)

(73) Assignee: SUMITOMO WIRING SYSTEMS, LTD., Yokkaichi-shi (JP)

(21) Appl. No.: 18/107,095

(22) Filed: Feb. 8, 2023

(30) Foreign Application Priority Data
Feb. 24, 2022 (JP) 2022-026652

(51) Int. Cl. H01B 9/02; H01B 13/00

(52) U.S. Cl. CPC H01B 9/02; H01B 13/0036

(57) ABSTRACT

A shielded cable including: a core wire; an insulating coating covering an outer circumference of the core wire; an electromagnetic shield covering an outer circumference of the insulating coating; a first tubular body covering an outer circumference of the electromagnetic shield; and a second tubular body, arranged on an outer circumference of the first tubular body.

### BACKGROUND

The present disclosure relates to a shielded cable and a shielded-cable manufacturing apparatus.

A shielded cable includes a core wire, an insulating coating covering the outer circumference of the core wire, an electromagnetic shield member covering the outer circumference of the insulating coating, and a first tubular body covering the outer circumference of the electromagnetic shield member. The electromagnetic shield member includes a folded-back portion at a length-direction end portion thereof. The folded-back portion is arranged on the outer circumferential surface of the first tubular body. Furthermore, the folded-back portion is crimped by a second tubular body that is made of a metal, for example, and that surrounds the outer circumference of the folded-back portion.

The second tubular body is crimped to the folded-back portion of the electromagnetic shield member, which is arranged inside the second tubular body, as a result of the second tubular body being sandwiched and pressed by first and second dies. For example, JP 2001-326053A discloses an apparatus for pressing a tubular body using first and second dies.

### SUMMARY

There is a concern that a burr protruding toward the outer-circumferential side from the second tubular body may be formed as a result of part of the second tubular body making its way between the parting surfaces of the first and second dies when the second tubular body is pressed by the first and second dies. If a burr is formed on the second tubular body, it may become impossible to fit the second tubular body into a fitting portion of a mating connector.

An exemplary aspect of the disclosure provides a shielded cable and a shielded-cable manufacturing apparatus that allow the second tubular body to be reliably fitted into a mating connector.

A shielded cable according to the present disclosure includes: a core wire; an insulating coating covering an outer circumference of the core wire; an electromagnetic shield covering an outer circumference of the insulating coating; a first tubular body covering an outer circumference of the electromagnetic shield; and a second tubular body arranged on an outer circumference of the first tubular body, wherein: the electromagnetic shield includes a folded-back portion in which a length-direction end of the electromagnetic shield is folded back toward an outer-circumferential side of the first tubular body, the second tubular body includes a crimped portion and a connection portion so as to be integrated with one another, the crimped portion having the shape of a polygonal tube and including a plurality of corners, and the connection portion having a cylindrical shape and being formed next to the crimped portion in an axial direction of the second tubular body, the folded-back portion is arranged inside the crimped portion and crimped to the crimped portion, the crimped portion includes a protrusion that protrudes toward the outer-circumferential side from at least one corner among the plurality of corners, and a first length from a center axis of the second tubular body to a distal-end surface of the protrusion is no greater than a second length from the center axis to an outer-circumferential surface of the connection portion.

Furthermore, a shielded-cable manufacturing apparatus according to the present disclosure is a manufacturing apparatus for manufacturing the above-described shielded cable, and includes a crimping machine that includes first and second dies that form the crimped portion by sandwiching and pressing a cylindrical material, wherein the first die includes a pair of arrangement surfaces that face one another, the material is arranged between the pair of arrangement surfaces, and the arrangement surfaces each include a protrusion shaping surface that forms the distal-end surface of the protrusion when the material is pressed by the first and second dies.

The shielded cable and the shielded-cable manufacturing apparatus according to the present disclosure exhibit the effect of allowing the second tubular body to be reliably fitted into a mating connector.

### BRIEF DESCRIPTION OF THE DRAWINGS

FIG. 1 is a perspective view of a shielded cable according to an embodiment.

FIG. 2 is a cross-sectional view of the shielded cable according to the embodiment.

FIG. 3 is a front view of the shielded cable according to the embodiment.

FIG. 4 is a schematic diagram illustrating the manufacturing of the shielded cable according to the embodiment.

FIG. 5 is a schematic diagram illustrating the manufacturing of the shielded cable according to the embodiment.

FIG. 6 is a schematic diagram illustrating the manufacturing of the shielded cable in which a crimping machine according to a modification is used.

FIG. 7 is a schematic diagram illustrating the manufacturing of the shielded cable in which the crimping machine according to the modification is used.

### DETAILED DESCRIPTION OF EMBODIMENTS

### Description of Embodiments of Present Disclosure

First, aspects of the present disclosure will be listed and described.

A Shielded Cable According to the Present Disclosure

(1) includes: a core wire; an insulating coating covering the outer circumference of the core wire; an electromagnetic shield member covering the outer circumference of the insulating coating; a first tubular body covering the outer circumference of the electromagnetic shield member; and a second tubular body arranged on the outer circumference of the first tubular body, wherein the electromagnetic shield member includes a folded-back portion in which a length-direction end portion of the electromagnetic shield member is folded back toward the outer-circumferential side of the first tubular body, the second tubular body includes a crimped portion and a connection portion so as to be integrated with one another, the crimped portion having the shape of a polygonal tube and including a plurality of corner portions, and the connection portion having a cylindrical shape and being formed next to the crimped portion in an axial direction of the second tubular body, the folded-back portion is arranged inside the crimped portion and crimped to the crimped portion, the crimped portion includes a protruding portion that protrudes toward the outer-circumferential side from at least one corner portion among the plurality of corner portions, and a first length from the center axis of the second tubular body to a distal-end surface of the protruding portion is no greater than a second length from the center axis to the outer-circumferential surface of the connection portion.

According to this configuration, a configuration is obtained in which the crimped portion does not interfere with a fitting portion of a mating connector when the second tubular body is fitted into the mating connector and an electrical contact with the mating connector is formed by the connection portion of the second tubular body. Thus, the second tubular body can be reliably fitted into the mating connector even when a configuration is adopted in which a protruding portion is formed on the crimped portion.

(2) The plurality of corner portions include a first corner portion that includes the protruding portion and a second corner portion that does not include the protruding portion, and the first length is greater than a third length from the center axis to the vertex of the second corner portion. According to this configuration, the second tubular body can be reliability fitted into the mating connector when a configuration is adopted in which the first corner portion protrudes further toward the outer-circumferential side than the second corner portion does.

(3) Two protruding portions are provided, and the two protruding portions are arranged on a same straight line that is orthogonal to the center axis.

According to this configuration, the second tubular body can be reliably fitted into the mating connector when a configuration is adopted in which two protruding portions are arranged on the same straight line.

(4) The crimped portion includes a plurality of wall portions that each connect two adjacent corner portions among the plurality of corner portions, and the plurality of wall portions each include a projection that is plastically deformed so as to protrude toward the inner-circumferential side of the crimped portion.

According to this configuration, greater crimping strength with respect to the folded-back portion can be obtained due to the projections.

(5) Furthermore, a shielded-cable manufacturing apparatus according to the present disclosure is a manufacturing apparatus for manufacturing the above-described shielded cable, and includes a crimping machine that includes first and second dies that form the crimped portion by sandwiching and pressing a cylindrical material, wherein the first die includes a pair of arrangement surfaces that face one another, the material is arranged between the pair of arrangement surfaces, and the arrangement surfaces each include a protruding-portion-shaping surface that forms the distal-end surface of the protruding portion when the material is pressed by the first and second dies.

According to this configuration, protruding portions allowing the first length to be no greater than the second length can be formed by the protruding-portion-shaping surfaces of the arrangement surfaces. Thus, the second tubular body can be reliably fitted into the mating connector even when a configuration is adopted in which protruding portions are formed on the crimped portion of the second tubular body.

(6) The distance between the pair of arrangement surfaces is set so as to be equal to the outer diameter of the material.

According to this configuration, protruding portions allowing the first length to be equal to the second length can be formed by the protruding-portion-shaping surfaces of the arrangement surfaces.

(7) The first die includes a parting surface and a pair of extending walls that extend perpendicularly from the parting surface, the pair of extending walls respectively include inner surfaces that face one another, and the inner surfaces of the pair of extending walls form the arrangement surfaces. According to this configuration, the arrangement surfaces can be formed on the inner surfaces of the extending walls provided in the first die.

### Details of Embodiment of Present Disclosure

Specific examples of the shielded cable and the shielded-cable manufacturing apparatus according to the present disclosure will be described below with reference to the drawings. In the drawings, some configurations may be illustrated in an exaggerated or simplified manner for convenience of description. Furthermore, the dimension ratio between portions may differ between drawings. In addition, in the present specification, the term “orthogonal” not only includes being strictly orthogonal to one another, but also includes being substantially orthogonal to one another within a range in which the operations and effects of the present embodiment are achieved.

### Configuration of Shielded Cable 10

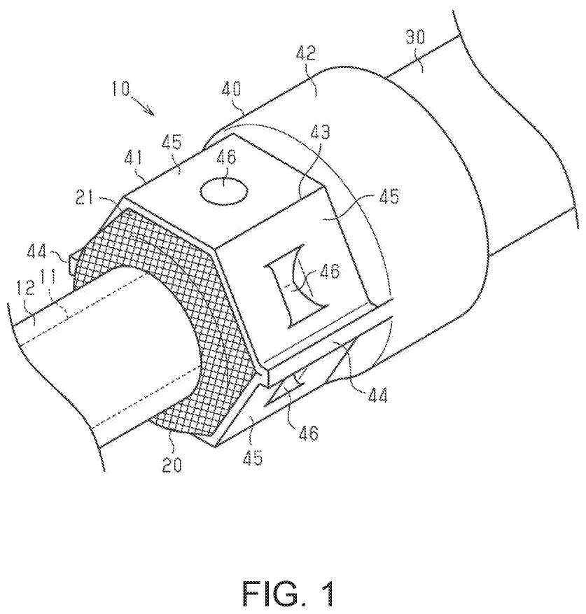

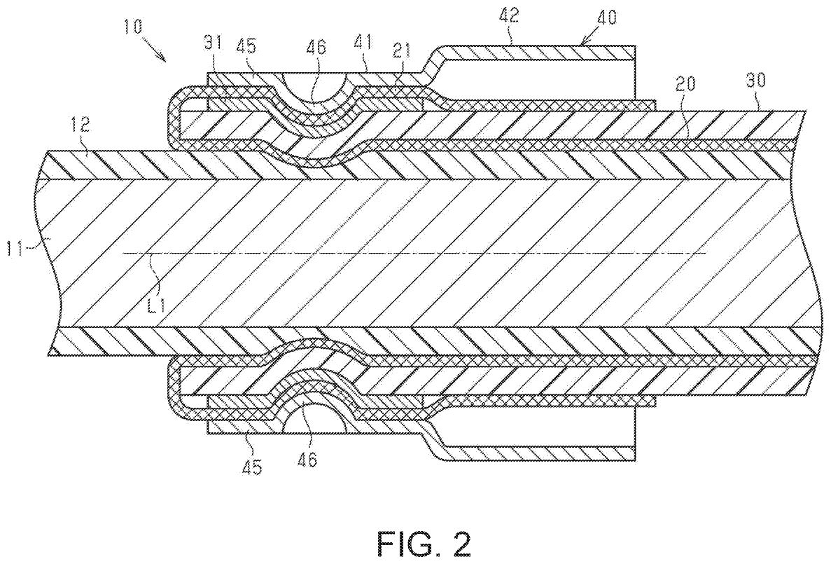

As illustrated in FIGS. 1 and 2, a shielded cable 10 according to the present embodiment includes a core wire 11, an insulating coating 12, an electromagnetic shield member 20 (electromagnetic shield), a sheath 30, a first tubular body 31, and a second tubular body 40. For example, the shielded cable 10 is used in a high-voltage harness for vehicles. That is, the shielded cable 10 is a high-voltage cable that can withstand high voltage and high current, for example.

The core wire 11 is electroconductive. For example, as the core wire 11, a stranded wire obtained by stranding a plurality of metal strands or a single core wire made from a single conductor may be used. For example, as a single core wire, a columnar conductor made from one columnar metal rod having a solid internal structure, a tubular conductor having a hollow internal structure, or the like may be used. For example, a metal material such as a copper-based material or an aluminum-based material may be used as the material for the core wire 11.

The insulating coating 12 covers the outer circumference of the core wire 11. The insulating coating 12 is electrically insulative. For example, the insulating coating 12 covers the outer-circumferential surface of the core wire 11 over the entire circumferential direction. For example, the insulating coating 12 is constituted by an insulative resin material.

The electromagnetic shield member 20 covers the outer circumference of the insulating coating 12. For example, the electromagnetic shield member 20 covers the outer-circumferential surface of the insulating coating 12 over the entire circumferential direction. The electromagnetic shield member 20 is electroconductive. The electromagnetic shield member 20 is connected to the ground in an unillustrated mating connector to which the shielded cable 10 is to be connected. For example, as the electromagnetic shield member 20, a braided wire in which a plurality of metal wires are woven together, or a braided wire in which metal and resin wires are combined and woven together may be used. For example, a metal material such as a copper-based material or an aluminum-based material may be used as the material for the metal wires.

The sheath 30 covers the outer circumference of the electromagnetic shield member 20. For example, the sheath 30 is constituted by an insulative resin material. For example, the sheath 30 covers the outer-circumferential surface of the core wire 11 over the entire circumferential direction. For example, the sheath 30 covers the outer circumference of the magnetic shield member 20, the insulating coating 12, and the electromagnetic shield member 20 excluding both length-direction end portions thereof.

For example, the first tubular body 31 illustrated in FIG. 2 has a cylindrical shape. The first tubular body 31 is arranged on the outer-circumferential side of the sheath 30. The first tubular body 31 is electroconductive. For example, a metal material such as a copper-based material or an aluminum-based material may be used as the material for the first tubular body 31.

The electromagnetic shield member 20 includes a folded-back portion 21 at a length-direction end portion thereof. The folded-back portion 21 is formed by folding back, toward the outer-circumferential surface-side of the first tubular body 31, the length-direction end portion of the electromagnetic shield member 20 over the entire circumferential direction. The folded-back portion 21 is arranged on the outer-circumferential surface of the first tubular body 31. The folded-back portion 21 has an annular shape surrounding the outer circumference of the first tubular body 31.

### Configuration of Second Tubular Body 40

The second tubular body 40 is arranged on the outer circumference of the folded-back portion 21. In other words, the folded-back portion 21 is interposed between the first tubular body 31 and the second tubular body 40. The second tubular body 40 is electroconductive. For example, a metal material such as a copper-based material or an aluminum-based material may be used as the material for the second tubular body 40.

The second tubular body 40 is formed by pressing an axial-direction portion of a later-described cylindrical material M using a crimping machine 50. The second tubular body 40 includes a crimped portion 41 and a connection portion 42. The crimped portion 41 is a part of the second tubular body 40 that is formed by the crimping machine 50. By being plastically deformed as a result of being pressed by the crimping machine 50, the crimped portion 41 is crimped to the folded-back portion 21, which is arranged on the inner-circumferential side of the crimped portion 41. Note that the first tubular body 31 is arranged on the inner-circumferential side of the crimped portion 41. In the length direction of the shielded cable 10, the first tubular body 31 is shorter than the second tubular body 40.

The connection portion 42 is a part of the second tubular body 40 that is not machined by the crimping machine 50, and is a part in which the cylindrical shape of the material M is preserved. That is, the crimped portion 41 is formed in an axial-direction portion of the second tubular body 40, and the connection portion 42 is formed in the axial-direction part of the second tubular body 40 excluding the crimped portion 41. Accordingly, the second tubular body 40 includes the crimped portion 41 and the connection portion 42 arranged in the axial direction so as to be integrated with one another. The crimped portion 41 and the connection portion 42 have the shape of coaxially arranged tubes. The center axis of the crimped portion 41 and the center axis of the connection portion. 42 coincide with the center axis L1 of the second tubular body 40.

### Configuration of Crimped Portion 41

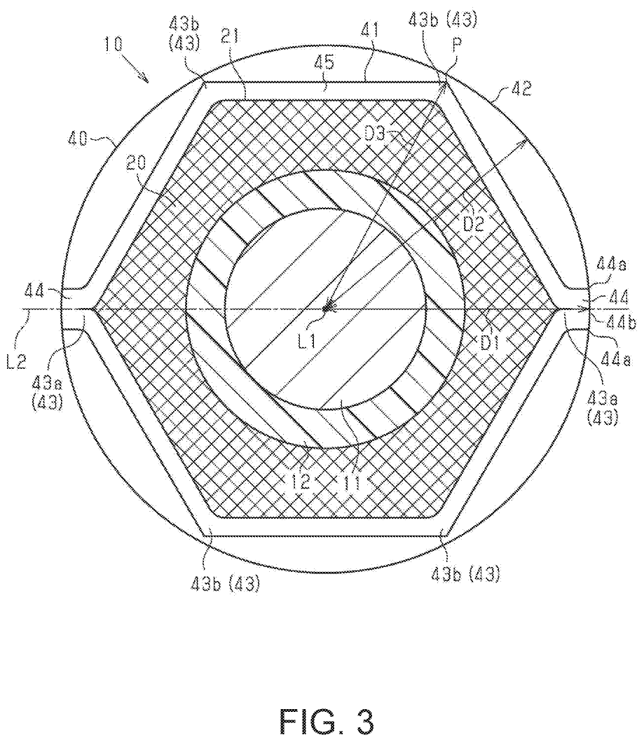

As illustrated in FIG. 3, the crimped portion 41 has the shape of a polygonal tube when seen from the axial direction of the second tubular body 40. For example, the crimped portion 41 has the shape of a regular hexagonal tube. That is, the crimped portion 41 includes six corner portions 43 (corners). The corner portions 43 all have the same angle. In the crimped portion 41 according to the present embodiment, the corner portions 43 have an interior angle of 120 degrees. Protruding portions 44 (protrusions) are formed in two corner portions 43 that are positioned facing one another among the six corner portions 43. In the following description, the corner portions 43 in which the protruding portions 44 are formed are referred to as first corner portions 43a, and the rest of the corner portions 43 are referred to as second corner portions 43b. That is, the crimped portion 41 includes two first corner portions 43a and four second corner portions 43b.

The protruding portions 44 protrude radially outward of the vertices of the second corner portions 43b. The two protruding portions 44 are arranged on a same straight line L2 that is orthogonal to the center axis L1. When seen from the direction along the center axis L1, the protruding portions 44 each protrude so as to have a rectangular shape. That is, each protruding portion 44 has two corners 44a when seen from the direction along the center axis L1.

Each protruding portion 44 has a distal end surface 44b that is the surface between the two corners 44a. The distal end surfaces 44b are the surfaces that are positioned at the distal ends of the protruding portions 44 in the protruding direction. In other words, the distal end surfaces 44b are the radially outer surfaces of the protruding portions 44. A first length D1 from the center axis L1 of the second tubular body 40 to the distal end surfaces 44b of the protruding portions 44 is no greater than a second length D2 from the center axis L1 to the outer-circumferential surface of the connection portion 42. In particular, in the present embodiment, the first length D1 and the second length D2 are set so as to be equal to one another. Furthermore, the first length D1 is greater than a third length D3 from the center axis L1 to the vertices P of the second corner portions 43b.

The crimped portion 41 includes a plurality of wall portions 45 (walls) that are partitioned from one another by the corner portions 43. In the crimped portion 41, the wall portions 45 are parts that connect two corner portions 43 that are adjacent in the circumferential direction. The circumferential wall of the crimped portion 41 is formed by the wall portions 45. The inner surface of each wall portion 45 is in contact with the folded-back portion 21 of the electromagnetic shield member 20.

As illustrated in FIGS. 1 and 2, each wall portion 45 includes a projection 46 that is plastically deformed so as to protrude toward the inner-circumferential side of the crimped portion 41. The projections 46 are formed as a result of the pressing by the later-described crimping machine 50. The projections 46 are in pressure contact with the folded-back portion 21 in a state such that the projections 46 bite into the folded-back portion 21.

The second tubular body 40 is to be fitted into an unillustrated fitting portion of the mating connector. In a state in which the second tubular body 40 is fitted into the fitting portion, the connection portion 42 forms an electrical contact with the mating-connector side. Thus, the folded-back portion 21 of the electromagnetic shield member 20 is connected to the ground via the second tubular body 40.

### Configuration of Manufacturing Apparatus

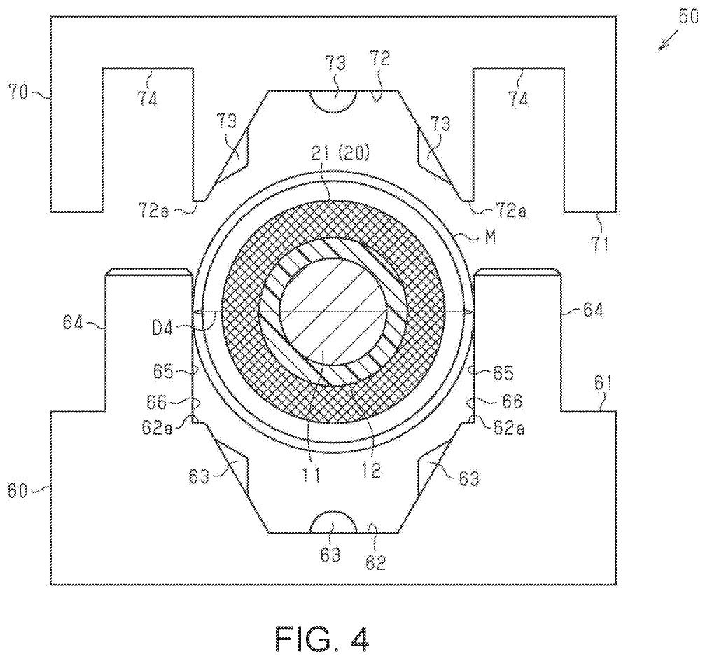

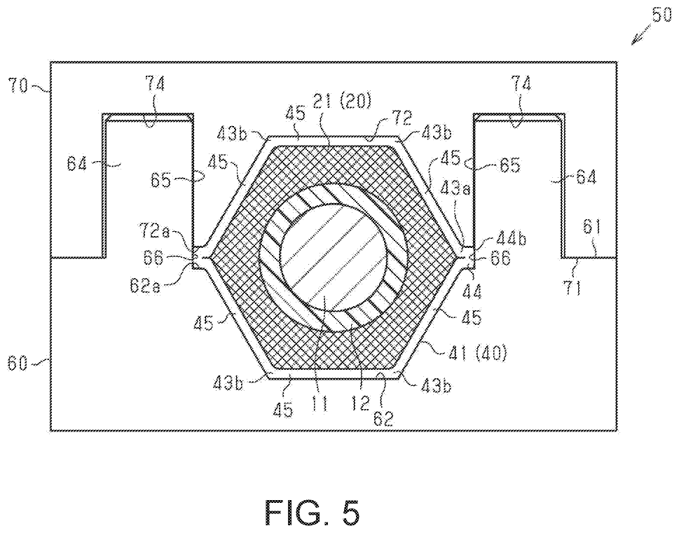

As illustrated in FIGS. 4 and 5, a manufacturing apparatus for manufacturing the shielded cable 10 includes the crimping machine 50, which forms the crimped portion 41 of the second tubular body 40. The crimping machine 50 includes a first the 60 and a second the 70. The first die 60 and the second die 70 form the crimped portion 41 by sandwiching and pressing an axial-direction portion of a cylindrical material M. Note that, prior to the pressing, a cross-section of the material M that is orthogonal to the axial direction exhibits a uniform circular shape throughout the axial direction.

The first the 60 includes a parting surface 61 and a first shaping recess 62. The first shaping recess 62 is a part that presses the material M. The first shaping recess 62 according to the present embodiment presses a circumferential half of the cylindrical material M. The first shaping recess 62 forms half of the plurality of wall portions 45; i.e., three wall portions 45 in the present embodiment. The first shaping recess 62 has three projections 63 that respectively form the projections 46 in the three wall portions 45 that are formed the first shaping recess 62.

The first shaping recess 62 has a protruding-portion-shaping portion 62a in each of the two width-direction end portions thereof. Each protruding-portion-shaping portion 62a is a part that forms a protruding portion 44 when the material M is pressed by the first die 60 and the second die 70.

The first die 60 includes a pair of extending walls 64 that extend perpendicularly from the parting surface 61. The extending walls 64 are respectively provided on both sides of the first shaping recess 62 in the width direction. The pair of extending walls 64 respectively include inner surfaces 65 that face one another. The inner surfaces 65 each have the shape of a flat surface that is perpendicular to the parting surface 61. The inner surfaces 65 are mutually parallel. The inner surfaces 65 each include a protruding-portion-shaping surface 66 that forms the distal end surface 44b of a protruding portion 44. The protruding-portion-shaping surfaces 66 are provided in the inner surfaces 65 in the proximal end portions of the extending walls 64. A distance D4 between the inner surfaces (35 of the pair of extending walls 64 is set so as to be equal to the outer diameter of the material. The outer diameter of the material M is twice the length of the above-described second length D2.

The second the 70 includes a parting surface 71 and a second shaping recess 72. The second shaping recess 72 is a part that presses the material M. The second shaping recess 72 forms the crimped portion 41 by sandwiching and pressing the axial-direction portion of the material M together with the first shaping recess 62. During the pressing, the parting surface 71 of the second the 70 comes into contact with the parting surface 61 of the first die 60. The second shaping recess 72 according to the present embodiment presses a circumferential half of the cylindrical material M. The second shaping recess 72 forms half of the plurality of wall portions 45; i.e., three wall portions 45 in the present embodiment. The second shaping recess 72 has three projections 73 that respectively form the projections 46 in the three wall portions 45 that are formed by the second shaping recess 72.

The second shaping recess 72 has a protruding-portion-shaping portion 72a in each of the two width-direction end portions thereof, Each protruding-portion-shaping portion 72a is a part that forms a protruding portion 44 when the material M is pressed by the first die 60 and the second die 70.

The second the 70 includes a pair of fitting recesses 74 that are recessed from the parting surface 71. The fitting recesses 74 are respectively provided on both sides of the second shaping recess 72 in the width direction. The pair of extending walls 64 are respectively fitted into the pair of fitting recesses 74.

Next, the pressing of the material M by the crimping machine 50 will be described.

First, as illustrated in FIG. 4, an axial-direction portion of the material M having the folded-back portion 21 arranged in the inside thereof is arranged between the pair of extending walls 64 of the first die 60. Here, the outer-circumferential surface of the material M comes into contact with the inner surfaces 65 of the extending walls 64.

Next, as illustrated in FIG. 5, the axial-direction portion of the material M is sandwiched and pressed using the first shaping recess 62 and the second shaping recess 72. Here, the pair of extending walls 64 of the first, die 60 are fitted into the pair of fitting recesses 74 of the second the 70. Furthermore, during the pressing, the parting surface 61 of the first die 60 and the parting surface 71 of the second die 70 come into contact with one another. In the following description, the state in which the parting surface 61 of the first, die 60 and the parting surface 71 of the second die 70 are in contact with one another is referred to as a pressing state.

In the pressing state, three wall portions 45 and two second corner portions 43b are formed in the first shaping recess 62. Also, three wall portions 45 and two second corner portions 43b are formed in the second shaping recess 72. In addition, the projections 46 of the crimped portion 41 are formed by the projections 63 of the first shaping recess 62 and the projections 73 of the second shaping recess 72. Furthermore, a pair of first corner portions 43a each including a protruding portion 44 are formed on a plane including the parting surfaces 61 and 71.

In the pressing state, the protruding-portion-shaping portions 62a of the first shaping recess 62 are not in contact with the protruding-portion-shaping portions 72a of the second shaping recess 72. In other words, the protruding-portion-shaping portions 62a and 72a are spaced away from one another in the pressing state. Furthermore, the protruding portions 44 are formed between the protruding-portion-shaping portions 62a and 72a spaced away from one another in the pressing state. Also, the distal end surfaces 44b of the protruding portions 44 are formed by the protruding-portion-shaping surfaces 66, which are parts of the inner surfaces 65 of the extending walls 64. As a result, of the protruding-portion-shaping portions 62a and 72a being spaced away from one another in the pressing state, the protruding portions 44 are prevented from being bitten off in the pressing state. Furthermore, the extending walls 64 prevent part of the material M being pressed from making its way into the space between the parting surfaces 61 and 71.

The crimped portion 41 crimped to the folded-back portion 21 is formed by being pressed by the first die 60 and the second the 70 as described above. The crimped portion 41 sandwiches the folded-back portion 21 between the first tubular body 31 and itself. The crimped portion 41 is crimped to the folded-back portion 21 throughout the entire circumferential direction thereof, and is crimped to the folded-back portion 21 with particularly great strength at the projections 46. Furthermore, the shape of the material M is preserved at the connection portion 42 of the second tubular body 40, which is not pressed by the crimping machine 50.

Next, the operations of the present embodiment will be described.

The distance D4 between the inner surfaces 65 of the pair of extending walls 64 is equal to the outer diameter of the material M. Furthermore, the distal end surfaces 44b of the protruding portions 44 are formed by the protruding-portion-shaping surfaces 66, which are parts of the inner surfaces 65. Thus, the first length D1 from the center axis L1 of the second tubular body 40 to the distal end surfaces 44b of the protruding portions 44 equals the radius of the material M, i.e., the second length. D2 from the center axis L1 to the outer-circumferential surface of the connection portion 42.

The effects of the present embodiment will be described.

(1) The crimped portion 41 of the second tubular body 40 includes protruding portions 44 that protrude toward the outer-circumferential side from two corner portions 43 (first corner portions 43a) among the plurality of corner portions 43. Furthermore, the first length D1 from the center axis L1 of the second tubular body 40 to the distal end surfaces 44b of the protruding portions 44 is no greater than the second length D2 from the center axis L1 to the outer-circumferential surface of the connection portion 42. According to this configuration, a configuration is obtained in which the crimped portion 41 does not interfere with a fitting portion of a mating connector when the second tubular body 40 is fitted into the fitting portion. Thus, the second tubular body 40 can be reliably fitted into the mating connector even when a configuration is adopted in which the protruding portions 44 are formed on the crimped portion 41.

(2) The plurality of corner portions 43 include first corner portions 43a that include the protruding portions 44 and second corner portions 43b that do not include the protruding portions 44. Furthermore, the first length D1 is greater than the third length. D3 from the center axis L1 to the vertices P of the second corner portions 43b. According to this structure, the second tubular body. 40 can be reliability fitted into the mating connector when a configuration is adopted in which the first corner portions 43a protrude further toward the outer-circumferential side than the second corner portions 43b do.

(3) Two protruding portions 44 are provided. The two protruding portions 44 are arranged on a same straight line L2 that is orthogonal to the center axis L1. According to this configuration, the second tubular body 40 can be reliably fitted into the mating connector when a configuration is adopted in which the two protruding portions 44 are arranged on the same straight line L2.

(4) The crimped portion 41 includes a plurality of wall portions 45 that each connect two corner portions 43 that are adjacent in the circumferential direction. Furthermore, the plurality of wall portions 45 each include a projection 46 that is plastically deformed so as to protrude toward the inner circumferential side of the crimped portion 41. According to this configuration, greater crimping strength with respect to the folded-back portion 21 can be obtained due to the projections 46.

(5) The manufacturing apparatus for manufacturing the shielded cable 10 includes a crimping machine 50 that forms the crimped portion 41 by sandwiching and pressing an axial-direction portion of a cylindrical material M. The first die 60 includes a pair of extending walls 64 that extend perpendicularly from the parting surface 61. The pair of extending walls 64 respectively include inner surfaces 65 that face one another and serve as arrangement surfaces. Furthermore, the inner surfaces 65 each include a protruding-portion-shaping surface 66 that forms the distal end surface 44b of a protruding portion 44 when the material M is pressed by the first die 60 and a second die 70. According to this configuration, protruding portions 44 allowing the first length D1 to be no greater than the second length D2 can be formed by the protruding-portion-shaping surfaces 66 of the extending walls 64.

(6) The distance D4 between the inner surfaces 65 of the pair of extending walls 64 is set so as to be equal to the outer diameter of the material M. According to this configuration, protruding portions 44 allowing the first length D1 to be equal to the second length D2 can be formed by the protruding-portion-shaping surfaces 66 of the extending walls 64.

(7) In a state in which the parting surfaces 61 and 71 are in contact with one another, the protruding-portion-shaping portions 62a of the first shaping recess 62 and the protruding-portion-shaping portions 72a of the second shaping recess 72 are spaced away from one another. Thus, the protruding portions 44 are prevented from being bitten off by the first die 60 and the second die 70 during the pressing.

### Modifications

The present embodiment can be implemented so as to be modified as follows. The present embodiment and the following modifications may be implemented so as to be combined with one another as long as there is no technical contradiction.

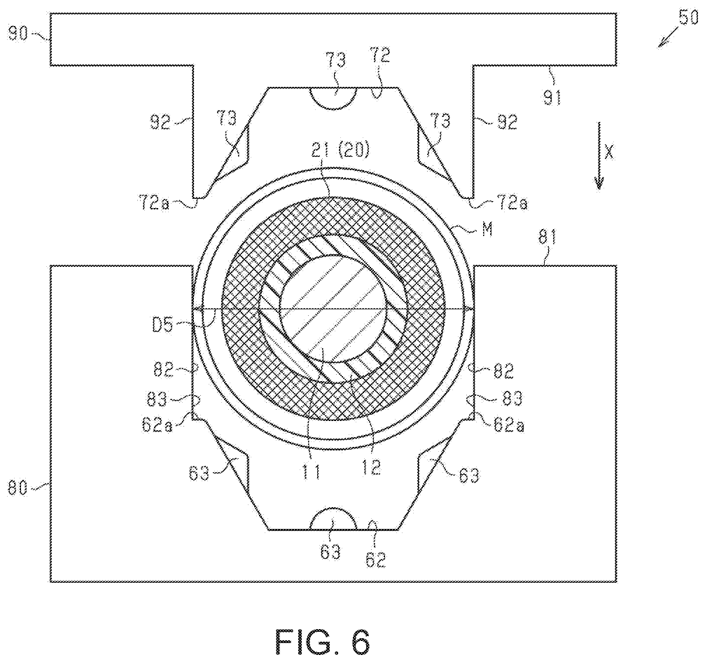

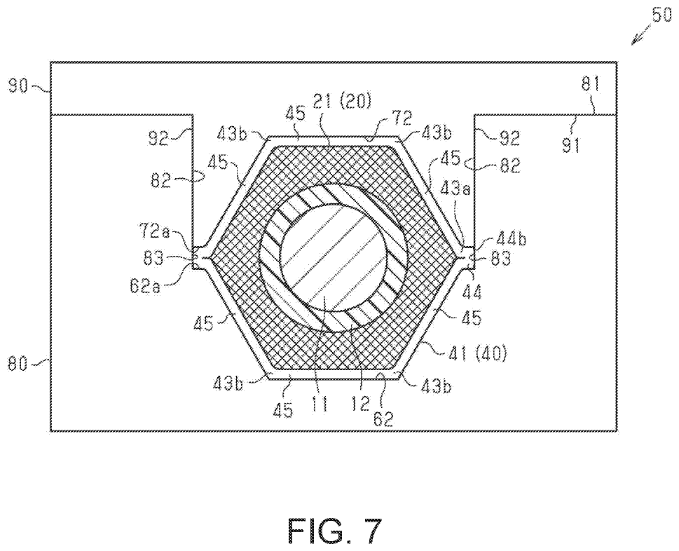

The configuration of the crimping machine 50 may be modified as illustrated in FIGS. 6 and 7.

The crimping machine 50 illustrated in FIGS. 6 and 7 includes a first die 80 and a second die 90. The first die 80 and the second die 90 form the crimped portion 41 by sandwiching and pressing an axial-direction portion of the cylindrical material M.

The first die 80 includes a parting surface 81 and the first shaping recess 62. Note that the same reference symbols are provided to configurations of the first die 80 similar to those of the first die GO according to the above-described embodiment, and detailed description thereof is omitted.

The first die 80 includes a pair of arrangement surfaces 82 that face one another in the width direction of the first die 80. The arrangement surfaces 82 are respectively provided on both sides of the first shaping recess 62 in the width direction. The arrangement surfaces 82 are mutually parallel. Furthermore, the arrangement surfaces 82 have the shape of flat surfaces extending along a press direction X of the first die 80 and the second the 90. In addition, in a direction along the press direction X, one end of the arrangement surfaces 82 is connected to the parting surface 81, and the other end of the arrangement surfaces 82 is connected to the protruding-portion-shaping portions 62a. The arrangement surfaces 82 each include a protruding-portion-shaping surface 83 that forms the distal end surface 44b of a protruding portion 44.

The material M is arranged between the pair of arrangement surfaces 82. A distance D5 between the pair of arrangement surfaces 82 is set so as to be equal to the outer diameter of the material M. The outer diameter of the material M is twice the length of the above-described second length D2.

The second die 90 includes a parting surface 91 and the second shaping recess 72, Note that the same reference symbols are provided to configurations of the second die 90 similar to those of the second die 70 according to the above-described embodiment, and detailed description thereof is omitted.

The second die 90 includes a pair of contact surfaces 92 that extend from the parting surface 91 toward the first die 80. The contact surfaces 92 have the shape of flat surfaces that are parallel with the arrangement surfaces 82. When the material M is pressed by the first die 80 and the second die 90, the pair of contact surfaces 92 respectively come into contact with the pair of arrangement surfaces 82. The second shaping recess 72 is positioned between the pair of contact surfaces 92. Furthermore, in a direction along the press direction X of the first die 80 and the second die 90, one end of the contact surfaces 92 is connected to the parting surface 91, and the other end of the contact surfaces 92 is connected to the protruding-portion-shaping portions 72a.

Next, the pressing of the material M by the first die 80 and the second die 90 will be described.

First, as illustrated in FIG. 6, an axial-direction portion of the material M having the folded-back portion 21 arranged in the inside thereof is arranged between the pair of arrangement surfaces 82 of the first die 80. Here, the outer-circumferential surface of the material M comes into contact with the arrangement surfaces 82.

Next, as illustrated in FIG. 7, the axial-direction portion of the material M is sandwiched and pressed using the first shaping recess 62 and the second shaping recess 72. Here, the pair of contact surfaces 92 of the second die 90 respectively come into contact with the pair of arrangement surfaces 82 of the first die 80. Furthermore, during the pressing, the parting surface 81 of the first die 80 and the parting surface 91 of the second die 90 come into contact with one another, in the following description, the state in which the parting surface 81 of the first die 80 and the parting surface 91 of the second die 90 are in contact with one another is referred to as a pressing state.

In the pressing state, the crimped portion 41 is formed by the first shaping recess 62 and the second shaping recess 72. Furthermore, the protruding portions 44 are formed between the protruding-portion-shaping portions 62a and 72a spaced away from one another in the pressing state. The distal end surfaces 44b of the protruding portions 44 are formed by the protruding-portion-shaping surfaces 83, which are parts of the arrangement surfaces 82.

Effects substantially similar to those of the above-described embodiment can be obtained with a configuration as illustrated in FIGS. 6 and 7. Specifically, the first die 80 includes a pair of arrangement surfaces 82 that face one another. The material M is arranged between the pair of arrangement surfaces 82. Furthermore, the arrangement surfaces 82 each include a protruding-portion-shaping surface 83 that forms the distal end surface 44b of a protruding portion 44 when the material M is pressed by the first die 80 and the second die 90. According to this configuration, protruding portions 44 allowing the first length D1 to be no greater than the second length D2 can be formed by the protruding-portion-shaping surfaces 83 of the arrangement surfaces 82.

Furthermore, the distance D5 between the pair of arrangement surfaces 82 is set so as to be equal to the outer diameter of the material M. According to this configuration, protruding portions 44 allowing the first length D1 to be equal to the second length D2 can be formed by the protruding-portion-shaping surfaces 83 of the arrangement surfaces 82.
In the crimped portion 41 according to the above-described embodiment, the corner portions 43 all have the same interior angle. However, there is no limitation to this, and a configuration may be adopted in which the interior angles of the corner portions 43 differ from one another.
In the above-described embodiment, protruding portions 44 are formed in two corner portions 43. However, there is no limitation to this, and a configuration may be adopted in which only one corner portion 43 or three or more corner portions 43 include protruding portions 44.
The crimped portion 41 according to the above-described embodiment has a hexagonal shape when seen from the center axis L1. However, the shape of the crimped portion 41 is not particularly limitation to this. That is, a configuration may be adopted in which the number of corner portions 43 that the crimped portion 41 includes is less than six or seven or more.
In the crimped portion 41 according to the above-described embodiment, a configuration is adopted in which the first length D1 is equal to the second length D2. However, there is no limitation to this, and a configuration may be adopted in which the first length D1 is no greater than the second length D2.
In the above-described embodiment, the folded-back portion 21 is sandwiched and fixed between the first tubular body 31 and the crimped portion 41 of the second tubular body 40. However, there is no limitation to this. For example, the first tubular body 31 may be omitted from the configuration according to the above-described embodiment, and a configuration may be adopted in which the folded-back portion 21 is sandwiched and fixed between the crimped portion 41 and the sheath 30, which serves as a first tubular body.
In the above-described embodiment, a braided wire is adopted as the electromagnetic shield member 20. However, other than this, a metal foil may be adopted as the electromagnetic shield member 20, for example.
The embodiment and the modifications disclosed herein are examples in every way, and the present disclosure is not limited to the embodiments disclosed herein, but defined in the claims, and intended to include all modifications within the meaning and the scope equivalent thereof.

What is claimed is:

1. A shielded cable comprising:
a core wire;
an insulating coating covering an outer circumference of the core wire;
an electromagnetic shield covering an outer circumference of the insulating coating;
a first tubular body covering an outer circumference of the electromagnetic shield; and
a second tubular body arranged on an outer circumference of the first tubular body, wherein:
the electromagnetic shield includes a folded-back portion in which a length-direction end of the electromagnetic shield is folded back toward an outer-circumferential side of the first tubular body,
the second tubular body includes a crimped portion and a connection portion so as to be integrated with one another, the crimped portion having the shape of a polygonal tube and including a plurality of corners, and the connection portion having a cylindrical shape and being formed next to the crimped portion in an axial direction of the second tubular body,
the folded-back portion is arranged inside the crimped portion and crimped to the crimped portion,
the crimped portion includes a protrusion that protrudes toward the outer-circumferential side from at least one corner among the plurality of corners, and
a first length from a center axis of the second tubular body to a distal-end surface of the protrusion is no greater than a second length from the center axis to an outer-circumferential surface of the connection portion.

2. The shielded cable according to claim 1, wherein:
the plurality of corners include a first corner that includes the protrusion and a second corner that does not include the protrusion, and
the first length is greater than a third length from the center axis to a vertex of the second corner.

3. The shielded cable according to claim 1, wherein:
the protrusion includes two protrusion; and
the two protrusions are arranged on a same straight line that is orthogonal to the center axis.

4. The shielded cable according to claim 1, wherein:
the crimped portion includes a plurality of walls that each connect two adjacent corners among the plurality of corners, and
the plurality of walls each include a projection that is plastically deformed so as to protrude toward the inner-circumferential side of the crimped portion.

5. A manufacturing apparatus for manufacturing the shielded cable according to claim 1, the shielded-cable manufacturing apparatus comprising
a crimping machine that includes first and second dies that form the crimped portion by sandwiching and pressing a cylindrical material, wherein:
the first die includes a pair of arrangement surfaces that face one another,
the material is arranged between the pair of arrangement surfaces, and
the arrangement surfaces each include a protrusion shaping surface that forms the distal-end surface of the protrusion when the material is pressed by the first and second dies.

6. The shielded-cable manufacturing apparatus according to claim 5, wherein a distance between the pair of arrangement surfaces is set so as to be equal to an outer diameter of the material.

7. The shielded-cable manufacturing apparatus according to claim 5, wherein:
the first die includes a parting surface and a pair of extending walls that extend perpendicularly from the parting surface,
the pair of extending walls respectively include inner surfaces that face one another, and
the inner surfaces of the pair of extending walls form the arrangement surfaces.
